(19) United States
(12) Patent Application Publication
(10) Pub. No.: US 2023/0132023 A1
(43) Pub. Date: Apr. 27, 2023

(54) AGGREGATED BORON NITRIDE PARTICLES AND METHOD FOR PRODUCING SAME

(71) Applicant: Denka Company Limited, Chuo-ku, Tokyo (JP)

(72) Inventors: Yusuke SASAKI, Chuo-ku, Tokyo (JP); Kenji MIYATA, Chuo-ku, Tokyo (JP); Michiharu NAKASHIMA, Chuo-ku, Tokyo (JP); Seiji SHIRAISHI, Chuo-ku, Tokyo (JP)

(73) Assignee: Denka Company Limited, Chuo-ku, Tokyo (JP)

(21) Appl. No.: 17/906,906

(22) PCT Filed: Mar. 29, 2021
(86) PCT No.: PCT/JP2021/013417

§ 371 Date: Sep. 21, 2022

(30) Foreign Application Priority Data
Mar. 31, 2020 (JP) 2020-062497

(51) Int. Cl. C01B 21/064

(52) U.S. Cl. CPC C01B 21/064; C01P 2004/50; C01P 2006/80; C01P 2004/30

(57) ABSTRACT

A method for producing an aggregated boron nitride particle, containing: a nitriding step of nitriding a particle containing boron carbide to obtain a particle containing boron carbonitride; and a decarburizing step of decarburizing the particle containing boron carbonitride to obtain an aggregated boron nitride particle, wherein, in the nitriding step, nitriding is performed so that boron carbide remains inside the particle containing boron carbonitride, and wherein, in the decarburizing step, the boron carbide remaining inside the particle containing boron carbonitride is removed.

### TECHNICAL FIELD

The present invention relates to an aggregated boron nitride particle and a method for producing the same.

### BACKGROUND ART

In electronic components such as power devices, transistors, thyristors, and CPUs, a heat dissipation member for efficiently dissipating heat generated during use is used. The heat dissipation member contains, for example, a ceramic particle having high thermal conductivity. As a ceramic particle, a boron nitride particle having characteristics such as high thermal conductivity, high insulation, and low relative permittivity is focused on.

Various methods are known as a method for producing a boron nitride particle. As one of the production methods, a method in which biboron trioxide (boric acid anhydride) and/or a precursor thereof is mixed into a product after firing boron carbide in a nitrogen atmosphere, and fired to remove by-product carbon may be exemplified (for example, refer to Patent Literature 1).

### CITATION LIST

### Patent Literature

[Patent Literature 1] Japanese Unexamined Patent Publication No. 2007-308360

### SUMMARY OF INVENTION

### Technical Problem

In the above method, for example, when boron carbide is nitrided, as described in Patent Literature 1, a sufficient temperature, time, and applied partial pressure of nitrogen are necessary, but it is desirable to simplify the process in order to produce a boron nitride particle more efficiently. On the other hand, impairment of characteristics such as thermal conductivity required for a boron nitride particle due to simplification of the process needs to be avoided.

Here, an object of one aspect of the present invention is to more easily produce a boron nitride particle having the same thermal conductivity as conventional ones.

### Solution to Problem

The inventors conducted extensive studies and found that, when a boron carbide particle is nitrided to obtain a boron carbonitride particle, even if boron carbide remains inside the boron carbonitride particle, the thermal conductivity of the finally obtained boron nitride particle is the same as that of conventional ones. That is, the inventors found that, since insufficient nitriding of a boron carbide particle does not adversely affect the thermal conductivity of the finally obtained a boron nitride particle, it is possible to simplify the step of nitriding a boron carbide particle (for example, a time required for nitriding can be shortened when a temperature and a pressure when nitriding is performed are the same).

One aspect of the present invention is a method for producing an aggregated boron nitride particle, containing: a nitriding step of nitriding a particle containing boron carbide to obtain a particle containing boron carbonitride; and a decarburizing step of decarburizing the particle containing boron carbonitride to obtain an aggregated boron nitride particle, wherein, in the nitriding step, nitriding is performed so that boron carbide remains inside the particle containing boron carbonitride, and wherein, in the decarburizing step, the boron carbide remaining inside the particle containing boron carbonitride is removed.

The particle containing boron carbonitride may have a residual proportion of the boron carbide of 5% or more.

In the nitriding step, a temperature when nitriding is performed may be 2,000° C. or lower.

In the nitriding step, a pressure when nitriding is performed may be 0.9 MPa or less.

In the nitriding step, a nitriding time may be 35 hours or less.

Another aspect of the present invention is an aggregated boron nitride particle containing: an outer shell part formed of aggregates of primary particles of boron nitride; and a hollow part surrounded by the outer shell part.

The aggregated boron nitride particle may have a cross section having an area ratio of the hollow part is 10% or more.

### Advantageous Effects of Invention

According to one aspect of the present invention, it is possible to more easily produce a boron nitride particle having the same thermal conductivity as conventional ones.

### BRIEF DESCRIPTION OF DRAWINGS

FIG. 1 is an SEM image of across section of an aggregated boron nitride particle of Example 1.

FIG. 2 is an SEM image of a cross section of an aggregated boron nitride particle of Example 2.

FIG. 3 is an SEM image of a cross section of an aggregated boron nitride particle of Example 3.

FIG. 4 is an SEM image of a cross section of an aggregated boron nitride particle of Comparative Example 1.

### DESCRIPTION OF EMBODIMENTS

Hereinafter, embodiments of the present invention will be described in detail.

A method for producing an aggregated boron nitride particle according to one embodiment includes a nitriding step of nitriding a particle containing boron carbide (hereinafter may be referred to as “a boron carbide particle”) is nitrided to obtain a particle containing boron carbonitride (hereinafter may be referred to as “a boron carbonitride particle”), and a decarburizing step of decarburizing the particle containing boron carbonitride to obtain an aggregated boron nitride particle.

In the nitriding step, a boron carbide particle is heated in an atmosphere in which a nitriding reaction proceeds, and thus the boron carbide particle is nitrided to obtain a boron carbonitride particle. In this case, the boron carbide particle are nitrided so that the boron carbide remains inside the obtained boron carbonitride particle.

The boron carbide particle can be produced by, for example, a known production method. Specifically, for example, a method in which boric acid and acetylene black are mixed and then heated in an inert gas atmosphere at 1,800 to 2,400° C. for 1 to 10 hours to obtain aggregated boron carbide may be exemplified. The aggregated boron carbide obtained by this method may be appropriately subjected to, for example, crushing, sieving, washing, impurities removal, and drying.

The average particle size of boron carbide particles is appropriately selected according to a desired average particle size of an aggregated boron nitride particle, and may be, for example, 5 μm or more, 15 μm or more, or 30 μm or more, and may be 80 μm or less, 70 μm or less, or 60 μm or less. When the average particle size of boron carbide particles is large, in the conventional method for producing an aggregated boron nitride particle, the step load for completely nitriding boron carbide particles in the nitriding step is large. On the other hand, in the production method of the present embodiment, since the boron carbide particle is not completely nitrided, particularly when boron carbide particle having a large average particle size is used (an aggregated boron nitride particle having a large average particle size are obtained), an advantage of simplifying the step is particularly exhibited.

The residual proportion of boron carbide in the boron carbonitride particle based on a total mass of the boron carbonitride particle is preferably 2 mass % or more, more preferably 4 mass % or more, still more preferably 6 mass % or more, and particularly preferably 8 mass % or more in order to further simplify the nitriding step, and the residual proportion is preferably 20 mass % or less, more preferably 15 mass % or less, and still more preferably 12 mass % or less in order to improve thermal conductivity of the obtained an aggregated boron nitride particle. One embodiment of the present invention may be boron carbonitride particle containing boron carbide remaining in the above proportion.

The residual proportion of boron carbide in the boron carbonitride particle can be measured from a peak area ratio between a peak derived from boron carbonitride to a peak for boron carbide in the boron carbonitride particle (peak area of boron carbonitride/peak area of boron carbide) measured using an X-ray diffraction device. Specifically, the residual proportion of boron carbide in the boron carbonitride particle is measured from the peak area ratio of the boron carbonitride particle using a calibration curve showing the relationship between boron carbide and the peak area ratio. Boron carbonitride particles having no residual boron carbide and boron carbide particles are mixed using a Henschel mixer or the like so that a mixing ratio (mass ratio) of boron carbonitride particles:boron carbide particles is 80:20, 85:15, 90:10, and 95:5 and a peak area ratio of the obtained mixed powder is calculated, and the calibration curve is created from the relationship between the mixing ratio and the peak area ratio.

Here, the boron carbonitride particle having no residual boron carbide used for creating the calibration curve is a boron carbonitride particle substantially composed of only boron carbonitride, and for example, it can be produced by firing boron carbide powder in a nitrogen atmosphere of 0.7 to 1.0 MPa at 1,800° C. to 2,000° C. for 30 to 45 hours. The fact that the boron carbonitride particle is substantially composed of only boron carbonitride can be confirmed when only a peak derived from boron carbonitride is detected in the above X-ray diffraction measurement.

In addition, the boron carbide particle used for creating the calibration curve is boron carbide particle substantially composed of only boron carbide, and for example, it can be obtained by the following known production method. That is, for the boron carbide particle, boric acid and acetylene black are mixed, and then heated in an atmosphere of an inert gas such as nitrogen gas or argon gas at 1,800 to 2,400° C. for 1 to 10 hours, and boron carbide masses can be obtained. The boron carbide masses are crushed, then sieved, and appropriately subjected to washing, impurity removal, drying and the like and thus boron carbide particle can be obtained. Commercially available boron carbide particle (with a purity of 99.5% or more) may be used. The fact that the boron carbide particle is substantially composed of only boron carbide can be confirmed when only a peak derived from boron carbide is detected in the above X-ray diffraction measurement.

The atmosphere in which a nitriding reaction proceeds may be, for example, at least one selected from among nitrogen gas and ammonia gas, and nitrogen gas is preferable in consideration of ease of nitriding and cost. The content of nitrogen gas in the atmosphere is preferably 95 vol % or more, and more preferably 99.9 vol % or more.

Conditions for nitriding a boron carbide particle in such an atmosphere are set so that boron carbide remains inside the boron carbonitride particle, and preferably set so that having the residual proportion of boron carbide in the above boron carbonitride particle is satisfied. Specifically, boron carbide particle is gradually nitrided inward from the surface of the particle in the nitriding step. However, for example, when one or both of a temperature and a pressure when boron carbide particle is nitrided are lowered, since the progress of nitriding is slowed down, even if a time for which boron carbide particles are nitrided is the same, boron nitride remains inside the boron carbonitride particle. In addition, for example, if the time for which boron carbide particle is nitrided is shortened, even if the temperature and the pressure when nitriding is performed are the same, nitriding of the entire boron carbide particle does not occur, and boron nitride remains inside the boron carbonitride particle. That is, in order to increase the residual proportion of boron carbide in the boron carbonitride particle, one or both of the temperature and the pressure when boron carbide particle is nitrided should be lowered, or the time for which boron carbide particles are nitrided should be shortened.

The temperature when the boron carbide particle is nitrided is preferably 2,200° C. or lower, more preferably 2,100° C. or lower, and still more preferably 2,000° C. or lower in order for boron carbide to suitably remain inside the boron carbonitride particle. The temperature when boron carbide particle is nitrided is preferably 1,600° C. or higher, more preferably 1,700° C. or higher, and still more preferably 1,800° C. or higher in order to further shorten the nitriding time.

The pressure when the boron carbide particle is nitrided is preferably 10 MPa or less, more preferably 5 MPa or less, still more preferably 1 MPa or less, and particularly preferably 0.9 MPa or less in order for boron carbide to suitably remain inside the boron carbonitride particle. The pressure when the boron carbide particle is nitrided is preferably 0.1 MPa or more, more preferably 0.3 MPa or more, still more preferably 0.5 MPa or more, and particularly preferably 0.7 MPa or more in order to further shorten the time for which boron carbide particles are nitrided.

The time for which boron carbide particles are nitrided is preferably 35 hours or less, more preferably 25 hours or less, and still more preferably 15 hours or less in order for boron carbide to suitably remain inside the boron carbonitride particle. The time for which boron carbide particles are nitrided may be, for example, 0.5 hours or more, 1 hour or more, or 5 hours or more.

In the decarburizing step, the boron carbonitride particle is decarburized by heating a mixture containing the boron carbonitride particle obtained in the nitriding step and a boron source. Thereby, crystallized primary particles of boron nitride are generated, the primary particles are aggregated, boron carbide remaining inside the boron carbonitride particle is removed, and the aggregated boron nitride particle are obtained.

Examples of boron sources include boric acid, boron oxide, and mixtures thereof. In this case, as necessary, other additives used in the art may be additionally used. The mixing ratio of the boron carbonitride particle and the boron source is appropriately selected. When boric acid or boron oxide is used as the boron source, the proportion of boric acid or boron oxide with respect to 100 parts by mass of boron carbonitride may be, for example, 100 parts by mass or more, and is preferably 150 parts by mass or more, and may be, for example, 300 parts by mass or less, and is preferably 250 parts by mass or less.

The atmosphere in the decarburizing step may be an ordinary pressure (atmospheric pressure) atmosphere or a pressurized atmosphere. In the case of the pressurized atmosphere, the pressure in the decarburizing step is, for example, 0.5 MPa or less, and preferably 0.3 MPa or less.

In the decarburizing step, for example, first, a temperature is raised to a predetermined temperature (a temperature at which decarburization can start), and the temperature is then additionally raised to a holding temperature from the predetermined temperature. The predetermined temperature (the temperature at which decarburization can start) can be set according to the system, and may be, for example, 1,000° C. or higher or 1,500° C. or lower, and is preferably 1,200° C. or lower. The rate of raising the temperature from the predetermined temperature (the temperature at which decarburization can start) to the holding temperature may be, for example, 5° C./min or less, and is preferably 4° C./min or less, 3° C./min or less, or 2° C./min or less.

The holding temperature is preferably 1,800° C. or higher, and more preferably 2,000° C. or higher because favorable particle growth is likely to occur and thermal conductivity of the obtained boron nitride powder can be improved. The holding temperature is preferably 2,200° C. or lower, and more preferably 2,100° C. or lower.

A holding time at the holding temperature is appropriately selected within a range in which sufficient crystallization of boron nitride proceeds, and may be, for example, more than 0.5 hours, and is preferably 1 hour or more, more preferably 3 hours or more, and still more preferably 5 hours or more because favorable particle growth is likely to occur. The holding time in the holding temperature may be, for example, less than 40 hours, and is preferably 30 hours or less, and more preferably 20 hours or less in order to reduce a decrease in particle strength due to excessive particle growth and in order to reduce industrial inconvenience.

The aggregated boron nitride particle obtained as described above may be subjected to a step of classifying to obtain a boron nitride particle having a desired particle size diameter by sieving (classifying step). Thereby, it is possible to obtain an aggregated boron nitride particle having a desired average particle size.

The aggregated boron nitride particle obtained as described above is a particle in which primary particles of boron nitride are aggregated to form an aggregate. The primary particles of boron nitride may be, for example, scaly hexagonal boron nitride particles. In this case, a length of the primary particle of boron nitride in the longitudinal direction may be, for example, 1 μm or more and 10 μm or less.

The aggregated boron nitride particle according to one embodiment has an outer shell part formed of an aggregate of the primary particles of boron nitride and a hollow part surrounded by the outer shell part. The outer shell part is a part formed by decarburizing boron carbonitride in the decarburizing step. The hollow part is a part formed by removing boron carbide remaining inside the boron carbonitride particle in the decarburizing step. Therefore, the proportion of the hollow part in the aggregated boron nitride particle is determined according to the residual proportion of boron carbide in the boron carbonitride particle obtained in the nitriding step.

The aggregated boron nitride particle may have a cross section having an area ratio of the hollow part (a ratio of the cross-sectional area of the hollow part to a cross-sectional area of all the aggregated boron nitride particle) is 5% or more. The area ratio of the hollow part is preferably 10% or more, more preferably 15% or more, and still more preferably 20% or more in order to reduce the weight of the material, and is preferably 50% or less, and more preferably 40% or less or 30% or less in order to reduce a decrease in the mechanical strength of the aggregated boron nitride particle.

The fact that the aggregated boron nitride particle has the outer shell part and the hollow part can be confirmed by observing the cross section of the aggregated boron nitride particle using a scanning electron microscope (SEM). In addition, the area ratio of the hollow part of the aggregated boron nitride particle can be obtained by incorporating the cross-sectional image into image analysis software and performing calculation.

The average particle size of the aggregated boron nitride particles is preferably 20 μm or more, more preferably 25 μm or more, and still more preferably 30 μm or more, 40 μm or more, 50 μm or more or 60 μm or more in order to further improve thermal conductivity of the aggregated boron nitride particles, and is preferably 100 μm or less, and more preferably 90 μm or less in order for the particles to be suitably mixed with a resin and molded into a sheet.

The aggregated boron nitride particle described above is suitably used for, for example, a heat dissipation member. When the aggregated boron nitride particle is used for a heat dissipation member, for example, it is used as a resin composition mixed with a resin. That is, another embodiment of the present invention is a resin composition containing a resin and the aggregated boron nitride particle.

The content of the aggregated boron nitride particle based on a total volume of the resin composition is preferably 30 vol % or more, more preferably 40 vol % or more, and still more preferably 50 vol % or more in order to improve thermal conductivity of the resin composition and easily obtain excellent heat dissipation performance, and is preferably 85 vol % or less, more preferably 80 vol % or less, and still more preferably 70 vol % or less in order to reduce the occurrence of voids during molding and reduce a decrease in insulation and mechanical strength.

Examples of the resin include an epoxy resin, a silicone resin, silicone rubber, an acrylic resin, a phenol resin, a melamine resin, a urea resin, unsaturated polyester, a fluorine resin, polyimide, polyamide-imide, polyetherimide, polybutylene terephthalate, polyethylene terephthalate, polyphenylene ether, polyphenylene sulfide, fully aromatic polyester, a polysulfone, liquid crystal polymer, polyether sulfone, polycarbonate, a maleimide-modified resin, an acrylonitrile-butadiene-styrene (ABS) resin, an arylonitrile-acrylic rubber-styrene (AAS) resin, and an acrylonitrile-ethylene-propylene-diene rubber-styrene (AES) resin.

The content of the resin based on a total volume of the resin composition may be 15 vol % or more, 20 vol % or more, or 30 vol % or more, and may be 70 vol % or less, 60 vol % or less, or 50 vol % or less.

The resin composition may further include a curing agent that cures the resin. The curing agent is appropriately selected depending on the type of the resin. For example, when the resin is an epoxy resin, as the curing agent, a phenol novolac compound, an acid anhydride, an amino compound, and an imidazole compound may be exemplified. The content of the curing agent with respect to 100 parts by mass of the resin may be for example, 0.5 parts by mass or more or 1.0 part by mass or more, and may be 15 parts by mass or less or 10 parts by mass or less.

The resin composition may further contain boron nitride particles other than the aggregated boron nitride particle (for example, known boron nitride particles such as aggregated boron nitride particles having no hollow part).

### EXAMPLES

Hereinafter, the present invention will be described in detail with reference to examples. However, the present invention is not limited to the following examples.

### Example 1

A boron carbide powder having an average particle size of 55 μm was filled into a carbon crucible, and heated using a resistance heating furnace under conditions of 2,000° C. and 0.85 MPa in a nitrogen gas atmosphere for 10 hours, and thus boron carbide particle was nitrided so that boron carbide remained inside the particle to obtain boron carbonitride particle (B₄CN₄). The residual proportion of boron carbide in the obtained boron carbonitride particle was calculated. 100 parts by mass of the obtained boron carbonitride particle and 150 parts by mass of boric acid were mixed using a Henschel mixer, the mixture was then filled into a boron nitride crucible, and heated using a resistance heating furnace at an ordinary pressure in a nitrogen gas atmosphere at a holding temperature of 2,000° C. for a holding time of 5 hours, and thereby a coarse powder of the boron nitride particle was obtained. The coarse powder was crushed in a mortar for 10 minutes and then classified with a nylon sieve with a sieve mesh of 109 μm. Thereby, an aggregated boron nitride particle (an aggregate thereof: boron nitride powder) in which primary particles were aggregated to form aggregates was obtained.

### Example 2

An aggregated boron nitride particle was obtained under the same conditions as in Example 1 except that the time for which boron carbide particle was nitrided (heating time) was changed to 20 hours, and the boron carbide particle was nitrided so that boron carbide remained inside the particle.

### Example 3

An aggregated boron nitride particle was obtained under the same conditions as in Example 1 except that the time for which boron carbide particle was nitrided (heating time) was changed to 30 hours, and the boron carbide particle was nitrided so that boron carbide remained inside the particle.

### Comparative Example 1

An aggregated boron nitride particle was obtained under the same conditions as in Example 1 except that the time for which boron carbide particle was nitrided (heating time) was changed to 45 hours, and the boron carbide particle was nitrided so that boron carbide did not remain inside the particle.

The aggregated boron nitride particle of the examples and the comparative example were measured as follows. Table 1 shows the nitriding time (heating time) and the measurement results in the examples and the comparative example.

[Measurement of Residual Proportion of Boron Carbide]

The boron carbonitride particles obtained in the production step of Comparative Example 1 and the boron carbide powder used as a raw material in each example were mixed using a Henschel mixer so that a mass ratio (boron carbonitride:boron carbide) was 80:20, 85:15, 90:10, and 95:5, and thereby a mixed powder was obtained. Next, each mixed powder was fixed onto a glass cell attached to an X-ray diffraction device (“ULTIMA-IV” commercially available from Rigaku Corporation) to prepare a sample. X rays were emitted to the sample using the X-ray diffraction device, and peak areas of a peak (near 27°) derived from boron carbonitride and a peak (near 37°) of boron carbide were measured. A ratio of these peak areas (peak area of boron carbonitride/peak area of boron carbide) was calculated, and a calibration curve was created from the relationship between the mass ratio and the peak area ratio of each mixed powder. Here, when X-ray diffraction measurement was performed on the boron carbonitride particle used for creating the calibration curve in the same manner, only a peak derived from boron carbonitride was detected. In addition, when X-ray diffraction measurement was performed on the boron carbide powder used for creating the calibration curve in the same manner, only a peak derived from boron carbide was detected.

Next, in the same manner as when the calibration curve was created, for the boron carbonitride particle of Examples 1 to 3, the peak area ratio of boron carbonitride and boron carbide was calculated. Then, the residual proportion of boron carbide in the boron carbonitride particle was calculated from the calculated peak area ratio and the obtained calibration curve. The results are shown in Table 1.

[Measurement of Average Particle Size of Boron Nitride Powder]

An average particle size of the boron nitride powder was measured using a laser diffraction scattering type particle size distribution measuring device (“LS-13 320” commercially available from Beckman Coulter, Inc.) according to ISO13320: 2009. However, before the measurement process, the sample was measured without applying a homogenizer. The average particle size is a particle diameter (median diameter, d50) at 50% in a cumulative value in a cumulative particle size distribution. When the particle size distribution was measured, water was used as a solvent in which a boron nitride powder was dispersed, sodium hexametaphosphate was used as a dispersant, and the boron nitride powder was dispersed in a 0.125 mass % sodium hexametaphosphate aqueous solution. In this case, a value of 1.33 was used as a refractive index of water, and a value of 1.7 was used as a refractive index of the boron nitride powder.

[Measurement of Area Ratio of Hollow Part in Cross Section of the Aggregated Boron Nitride Particle]

An area ratio of the hollow part in the cross section of the aggregated boron nitride particle was measured as follows. First, for the produced aggregated boron nitride particle, as a pretreatment for observation, the aggregated boron nitride particle was embedded with an epoxy resin. Next, the cross section was processed by a cross section polisher (CP) method, and fixed to a sample stand. After the fixing, an osmium coating was performed on the cross section.

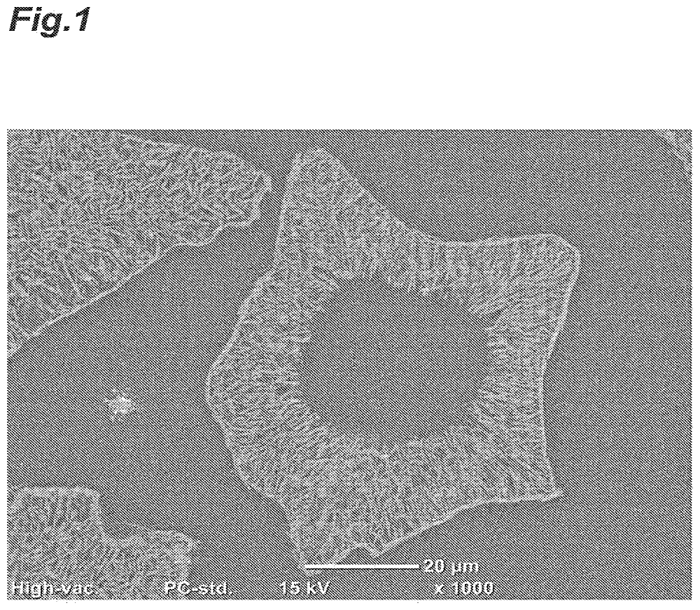

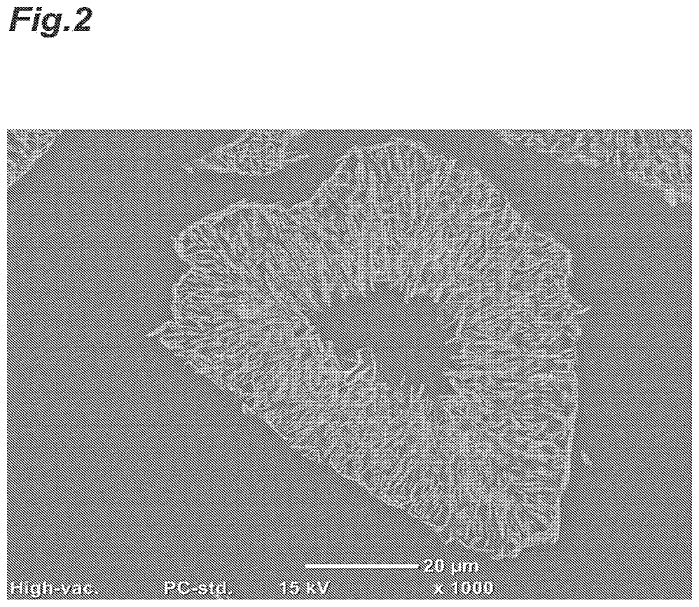

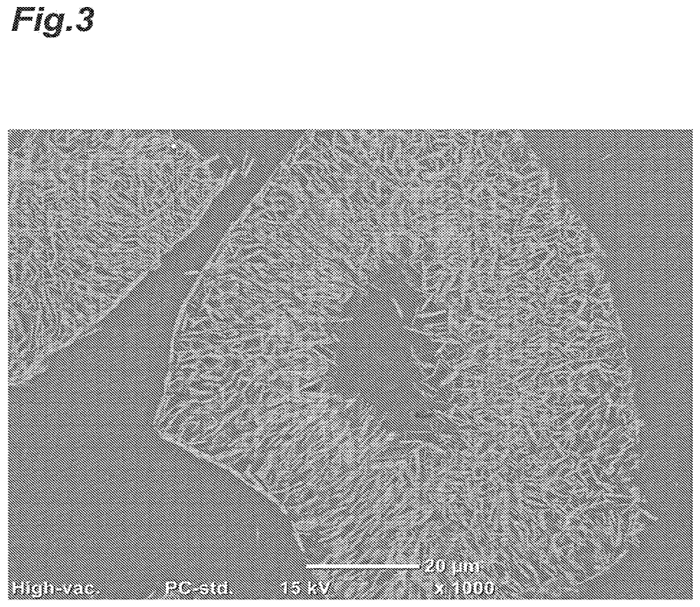

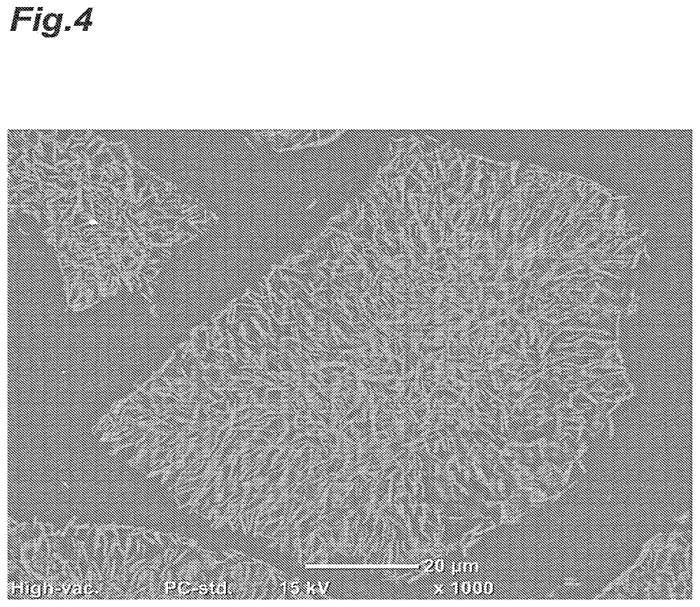

The cross section was observed using a scanning electron microscope (“JSM-6010LA” commercially available from JEOL Ltd.) at an observation magnification of 100 to 1,000. The obtained cross-sectional image of the aggregated boron nitride particle was incorporated into image analysis software (“Mac-view” commercially available from Mountech Co., Ltd.), and the area ratio of the hollow part in the cross-sectional image of the aggregated boron nitride particle was measured. In addition, FIGS. 1 to 4 show SEM images of the cross sections of the aggregated boron nitride particle obtained in Examples 1 to 3 and Comparative Example 1.

[Measurement of Thermal Conductivity]

A mixture containing 100 parts by mass of a naphthalene type epoxy resin (“HP4032” commercially available from DIC) and 10 parts by mass of imidazoles (“2E4MZ-CN” commercially available from Shikoku Chemical Corporation)) as a curing agent was mixed so that the obtained boron nitride powder was 50 vol %, and thereby a resin composition was obtained. This resin composition was defoamed under a reduced pressure of 500 Pa for 10 minutes, and applied to a PET sheet to have a thickness of 1.0 mm. Then, press-heating and pressurizing were performed for 60 minutes under conditions of a temperature of 150° C. and a pressure of 160 kg/cm² to produce a 0.5 mm sheet.

A measurement sample with a size of 10 mm×10 mm was cut out from the obtained sheet, and a thermal diffusivity A (m²/sec) of the measurement sample was measured by a laser flash method using a xenon flash analyzer (“LFA447NanoFlash” commercially available from NETZSCH). In addition, a specific gravity B (kg/m³) of the measurement sample was measured by an Archimedes method. In addition, a specific heat capacity C (J/(kg-K)) of the measurement sample was measured using a differential scanning calorimeter (“ThermoPlusEvoDSC8230” commercially available from Rigaku Corporation). A thermal conductivity H (W/(m·K)) was obtained from a formula of H=A×B×C using these physical property values.

TABLE 1

| | Example | Example | Example | Comparative |
|---|---|---|---|---|
| | 1 | 2 | 3 | Example 1 |
| Nitriding time | 10 | 20 | 30 | 45 |
| [hour] | | | | |
| Residual proportion | 10.7 | 8.6 | 2.7 | 0 |
| of boron carbide in | | | | |
| boron carbonitride | | | | |
| particle [mass %] | | | | |
| Average particle | 87.6 | 86.6 | 86.0 | 89.4 |
| size of aggregated | | | | |
| boron nitride | | | | |
| particles [μm] | | | | |
| Area ratio of hollow | 25.2 | 10.0 | 7.6 | 0 |
| part in cross section | | | | |
| of aggregated boron | | | | |
| nitride particle [%] | | | | |
| Thermal | 17.2 | 17.3 | 18.9 | 17.0 |
| conductivity | | | | |
| [W/(m · K)] | | | | |

1. A method for producing an aggregated boron nitride particle, comprising:
a nitriding step of nitriding a particle comprising boron carbide to obtain a particle comprising boron carbonitride; and
a decarburizing step of decarburizing the particle comprising boron carbonitride to obtain an aggregated boron nitride particle,
wherein, in the nitriding step, nitriding is performed so that boron carbide remains inside the particle comprising boron carbonitride, and
wherein, in the decarburizing step, the boron carbide remaining inside the particle comprising boron carbonitride is removed.

2. The method according to claim 1, wherein the particle comprising boron carbonitride has a residual proportion of the boron carbide of 5% or more.

3. The method according to claim 1, wherein, in the nitriding step, a temperature when nitriding is performed is 2000° C. or lower.

4. The method according to claim 1, wherein, in the nitriding step, a pressure when nitriding is performed is 0.9 MPa or less.

5. The method according to claim 1, wherein, in the nitriding step, a nitriding time is 35 hours or less.

6. An aggregated boron nitride particle comprising:
an outer shell part formed of aggregates of primary particles of boron nitride; and
a hollow part surrounded by the outer shell part.

7. The aggregated boron nitride particle according to claim 6, having a cross section having an area ratio of the hollow part of 5% or more.
